(19) United States
(12) Patent Application Publication
(10) Pub. No.: US 2007/0267967 A1
(43) Pub. Date: Nov. 22, 2007

(54) White light LED light source and method for producing its phosphor powder

(75) Inventor: Soshchin Naum, Changhua City (TW)

Correspondence Address: John G. Chupa;Law Offices of John Chupa & Associates, P.C., Suite 50, 28535 Orchard Lake Road, Farmington Hills, MI, 48334, US

(73) Assignee: Shian-Meng Chen Tsai

(21) Appl. No.: 11/701,950

(22) Filed: Feb. 2, 2007

(30) Foreign Application Priority Data
May 19, 2006 (TW) 095117823

(51) Int. Cl. H01J 1/63

(52) U.S. Cl. 313/503

(57) ABSTRACT

The invention discloses a white light LED light source and a method for producing its phosphor powder. The white LED consists of at least two different heterostructures radiating blue and ultraviolet lights of different wavelengths, and also includes a spectrum converter activated for producing a radiation to be mixed with the radiation of a nitride heterostructure to produce a white light and modulating the hue of the white light by changing the electric power of the heterostructure. The base of the spectrum converter is a phosphor powder Mg(Ca, Sr, Ba)₃Si₂O₈:Me⁺²,⁺³Hal_{2,3}, and a radiation with a wavelength from 520 nm to 650 nm can be obtained by changing the proportion of these ingredients. The activation core of the phosphor powder is composed of Eu⁺²+Y⁺³+Cl⁻¹, Eu⁺²+Pr⁺³+F⁻¹ or Ce⁺³+Mn⁺²+Cl⁻¹, and an element of such combination can activate an energy transmission. The invention also provides a method of producing a white LED phosphor powder.

### BACKGROUND OF THE INVENTION

1. Field of the Invention

The present invention relates to a white light emitting diode (LED) light source and a method for producing its phosphor powder, and more particularly to a white light LED light source and a method for producing its phosphor powder that can emit blue light radiation and/or ultraviolet radiation, and the LED includes a phosphor powder that can absorb blue light radiation and/or ultraviolet radiation and even radiations of other frequency bands.

2. Description of the Related Art

Unlike other light sources, an organic light emitting diode (OLED) features a longer life expectancy, a smaller volume, a shock resistance and a narrowband radiation. In practical applications, an LED cannot effectively achieve a wideband color light radiation by its semiconductor material, and thus an inorganic phosphor powder is used to convert a large portion of radiations of the heterostructure into long-wave radiations, so that the LED technology can be used in preaxial applications. The device for converting the phosphor powder is a spectrum converter.

A laser diode light emitting device that includes a blue light LED or an interaction with a phosphor powder mixture has been disclosed in a patent (WO 00/33390).

To produce white lights, an LED with a spectrum ranging 420 nm˜470 nm and a phosphor powder mixture containing at least two phosphor powders are needed. Therefore, two kinds of phosphor powders having different radiation spectra are needed. This kind of phosphor powder mixture includes a red ingredient and a green ingradient. Under such conditions, the two colors are mixed with the blue light emitted from the LED to produce a white light. Alternatively, the material of a single ingredient can be used to substitute the phosphor powder mixture. However, both quality and quantity of emitting lights will be reduced in this situation.

In general, the required quality and quantity of a white light source used for general illuminations are high, and the users of a light source particularly European or North American users tend to use a warm color light with a ratio color temperature from 2700 K to 5000 K.

In the patent WO 00/33389, Ba₂SiO₄:Eu²⁺ is used as a phosphor powder for changing the light emitted by the blue light emitting diode, but the maximum radiation of the phosphor powder Ba₂SiO₄:Eu²⁺ occurs at a position below 505 nm, and thus this combination cannot provide white light reliably.

In the “Journal of Alloys and Compounds” 260 (1997), p. 93-97 published by C. X. M. Poort (S. H. M. Poort), the “Optical property of orthosilicate and orthophosphate being activated by Eu²⁺” can obtain the same properties of Ba₂SiO₄ and phosphate such as KBaPO₄ and KSrPO₄ being activated by Eu²⁺. The journal also mentioned that the radiation spectrum of Ba₂SiO₄ being activated by Eu²⁺ occurs at 505 nm.

The structure of the two-element or three-element orthosilicate of Ba, Ca and Sr activated by the Eu²⁺ to obtain a white light has been disclosed in Russian Pat. No. 22251761, and the chemical formulas of phosphor powder are given below:

a) (2-x-y)SrO.x(Ba_{U},Ca_{V})O.(1-a-b-c-d)SiO₂.aP₂O₅bAl₂O₃cB₂O₃dGeO₂:yEu²⁺; where 0≦x≦1.6, 0.005<y<0.5, x+y≦1.6, 0≦a,b,c,d<0.5, u+v=1; and
b) (2-x-y)BaO.x(Sr_{U},Ca_{V})O.(1a-b-c-d)SiO₂.aP₂O₅bAl₂O₃cB₂O₃dGeO₂:yEu²⁺; where 0.01<x<1.6, 0.005<y<0.5, 0≦a,b,c,d<0.5 u+v=1, x*u>0.4.

Although this kind of three-element orthosilicate phosphor powders may produce yellow light radiations, the brightness of the semiconductor light source is not guaranteed. In addition, the LED produced by this kind of phosphor powder cannot have a ratio color temperature higher than the low-temperature white light radiation at 6000 K, which is a blemish of its application.

### SUMMARY OF THE INVENTION

In view of the shortcomings of the prior art, the inventor of the invention based on years of experience in the related industry to conduct extensive researches and experiments, and finally invented a white light emitting diode (LED) light source and a method for producing its phosphor powder in accordance with the present invention.

Therefore, it is a primary objective of the present invention to provide a feasible solution and overcome the foregoing problems by providing a phosphor powder for a white light LED light source and a method of producing the phosphor powder that can produce a light source for LED radiations occurred at ultraviolet wave band and blue light wave band (370 nm˜490 nm), and this kind of light source adopting an improved phosphor powder can produce a more effective high-power white light, so that it can be applied for illuminations.

Another objective of the present invention is to provide a phosphor powder for white light LED light source that adopts one or more phosphor powder to achieve the possibility of modulating a ratio color temperature in a larger range, so as to satisfy the requirements of different users, and more particularly to the colors within an elliptical range of tolerance specified by the International Commission on Illumination (CIE).

A further objective of the present invention is to provide a phosphor powder for a white light LED light source and a method of producing the phosphor powder. The white light semiconductor light source comprises an indium gallium nitride short-wave heterostructure and a spectrum converter. The features of the light source includes at least two maximum radiations falling in a near-ultraviolet area of 360 nm˜400 nm (ultraviolet heterostructure) and 440 nm˜480 nm area (blue light heterostructure). The overlappped portion of the short-wave heterostructure radiation spectrum is 10%˜30% of the maximum radiation intensity. The spectrum converter is made of orthosilicate phosphor powder that uses a multi-layer film as its base, and the phosphor powder has a chemical formula Mg(Ca, Sr, Ba)₃Si₂O₈:(ΣMe^{2,3})(Hal)_{2,3}. The film has a light contact with a light emitting surface of a semiconductor heterostructure situated at a reflecting surface of a reflector and electrically coupled to the semiconductor light source.

To achieve the foregoing objectives, a white light LED light source of the invention is made of indium gallium nitride and comprises: an insulating crystal frame for carrying a first heterostructure and a second heterostructure, and the first heterostructure having an anode, a cathode and a light emitting surface, and the anode and cathode of the first heterostructure being exposed from the insulating crystal frame, and the second heterostructure disposed on a side of the first heterostructure and having an anode, a cathode and a light emitting surface, and the anode and cathode of the second heterostructure being exposed from the insulating crystal frame; a spectrum converter covered onto a light emitting surface above the first heterostructure and the second heterostructure; and an optical casing disposed above the spectrum converter and coupled to the insulating crystal frame to define an airtight status.

To achieve the foregoing objectives, a phosphor powder of a white light LED light source of the invention is made of orthosilicate, and has a chemical formula of Mg(Ca, Sr, Ba)₃Si₂O₈:(ΣMe^{2,3})(Hal)_{2,3}, and its activated light emitting spectrum includes a first limit and a second limit, such that if the base of the phosphor powder is activated by ions and the ion concentration of the base satisfies a specific atomic fraction, the phosphor powder radiation spectrum will be distributed in a green-yellow-orange visible spectrum area.

To achieve the foregoing objectives, a method for producing a phosphor powder for a white light diode comprises the steps of: weighing and mixing BaCO₃, SrCO₃, EuCl₂ and SiO₂ particles; adding MgCO₃ and CaCO₃ into the mixture; mixing the ingredients thoroughly and putting the ingredients into a crucible and then into a furnace with two partitioned areas; producing alkaline-earth metal orthosilicate and europium by decomposing carbonates in a first area of the furnace at a first temperature; adding a reversible gas mixture into a second area of the furnace at a second temperature; taking the crucible out from an exit of the furnace and putting the substance in the crucible into a solution; and using an instrument to test the dry phosphor powder and confirm its parameters.

To achieve the foregoing objectives, a method for producing a phosphor powder for a white light diode comprises the steps of: performing a gelation for a precipitant in a specific reactor; drying the gel to a water content with a specific concentration; grinding the gel into a powder by a grinder; putting the powder into a crucible; and heating the powder to a specific temperature to obtain the phosphor powder.

### BRIEF DESCRIPTION OF THE DRAWINGS

FIG. 1 is a schematic view of a white light LED light source according to a preferred embodiment of the present invention;

FIG. 2 is a flow chart of a method for producing a phosphor powder according to a preferred embodiment of the present invention; and

FIG. 3 is a flow chart of a method for producing a phosphor powder according to another preferred embodiment of the present invention.

### DETAILED DESCRIPTION OF THE PREFERRED EMBODIMENTS

The present invention uses the LED radiation occurred at ultraviolet wave band and blue light wave band (370 nm˜490 nm) as a light source, and the light source adopts an improved phosphor powder to produce a more effective high-power white light, such that the light source can be used for illuminations.

The present invention also overcomes the shortcomings of the prior art by adopting one or more phosphor powder to achieve the possibility of modulating a ratio color temperature in a larger range, so as to satisfy the requirements of different users, and more particularly to the colors within an elliptical range of tolerance specified by the International Commission on Illumination (CIE).

The present invention provides a white light semiconductor light source that comprises an indium gallium nitride short-wave heterostructure and a spectrum converter. The feature of the light source includes at least two maximum radiations falling in a near-ultraviolet area of 360 nm˜400 nm (ultraviolet heterostructure) and 440 nm˜480 nm area (blue light heterostructure). The overlappped portion of the short-wave heterostructure radiation spectrum is 10%˜30% of the maximum radiation intensity.

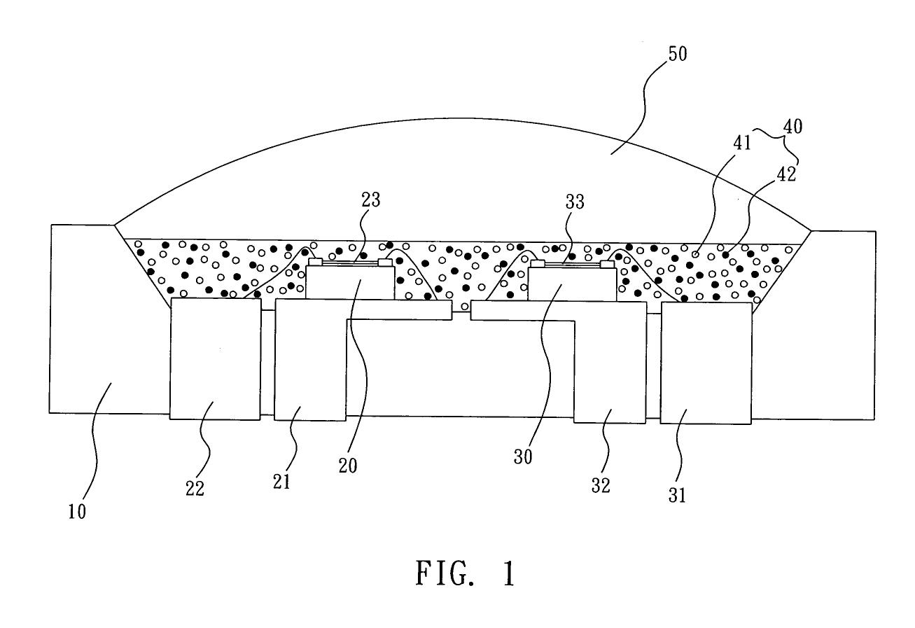

Referring to FIG. 1 for a schematic view of the structure of a white light LED light source according to a preferred embodiment of the present invention, the white light LED light source of the invention is made of indium gallium nitride and comprises an insulating crystal frame 10; a first heterostructure 20; a second heterostructure 30; a spectrum converter 40; and an optical casing 50.

The insulating crystal frame 10 is provided for carrying the first heterostructure 20 and the second heterostructure 30.

The first heterostructure 20 is disposed in the insulating crystal frame 10 and includes an anode 21, a cathode 22 and a light emitting surface 23, wherein the anode 21 and the cathode 22 are exposed from the insulating crystal frame 10, and the first heterostructure 20 is an ultraviolet heterostructure and has a maximum radiation including but not limited to 360 nm˜400 nm.

The second heterostructure 30 is disposed in the insulating crystal frame 10 and on a side including but not limited to the right side of the first heterostructure 20, and the second heterostructure 30 also includes an anode 31, a cathode 32 and a light emitting surface 33, wherein the anode 31 and the cathode 32 are exposed from the insulating crystal frame 10, and the second heterostructure 30 is a blue light heterostructure and has a maximum radiation including but not limited to 440 nm˜480 nm, and the overlapped portion of the radiation spectrum of the second heterostructure and the radiation spectrum of the first heterostructure 20 occupies 10%˜30% of the maximum radiation.

The spectrum converter 40 is covered onto a light emitting surface at the top of the first heterostructure 20 and the second heterostructure 30, wherein the spectrum converter 30 is formed by mixing a transparent organic resin 41 and a phosphor powder 42, and the phosphor powder 42 is made by a material including but not limited to orthosilicate, and its chemical formula is Mg(Ca, Sr, Ba)₃Si₂O₈:(ΣMe^{2,3})(Hal)_{2,3}. Unlike the activating agents of the prior art that use EU⁺², the activation elements of this phosphor powder 42 exist in the form of two-valent and three-valent positive ions.

The spectrum converter 40 is a light diffusion layer made of an organic compound and evenly coated with particles of phosphor powder 42. This organic compound includes but not limited to a high-temperature curing epoxy resin, polycarbonate or organosilicon compound. The compounds adopted by the present invention have a common feature of having a molecular weight ≧10000 of carbon atoms, so as to guarantee the compound layer to have sufficient tenacity for compensating the stress caused by temperature difference. Experiment results show that the phosphor powder particles in the compound layer fill 6%˜25% of the layer.

The optical casing 50 is disposed above the spectrum converter 40 and coupled with the insulating crystal frame 10 to define an air-sealed status.

The white light LED light source of the invention further comprises a reflector (not shown in the figure) for modulating the direction of radiating light of the first heterostructure 20, the second heterostructure 30 and the spectrum converter 40, and the reflector can be electrically coupled to a power supply of the white light LED light source.

Referring to Attachment 1, a curve of radiation spectra when the spectrum converter 40 in a form of phosphor powder is activated by ultraviolet rays emitted by the first heterostructure 20, and chromaticity coordinates of a spectrum converter 40 providing a radiation spectrum according to CIE1931 are illustrated.

Referring to Attachment 2, a curve of radiation spectra when the spectrum converter 40 in a form of phosphor powder is activated by blue lights emitted by the second heterostructure 30, and chromaticity coordinates of a spectrum converter 40 providing a radiation spectrum according to CIE1931 are illustrated.

Referring to Table 1, the physical light color parameters of a spectrum converter under two different activated states are listed.

TABLE 1

| | Light color parameter of spectrum converter | | | | |
|---|---|---|---|---|---|
| | in a form of phosphor powder | | | | |
| | | | | Peak | Main |
| | | Color | Color | wave- | wave- |
| Activation | Relative unit | coordinates | coordinates | length | length |
| Mode | Brightness | x, y | u, v | λp | λd |
| Ultraviolet | 76111 | 0.4353, | 0.2086, | 561.9 | 570 |
| Ray | | 0.5243 | 0.3736 | | |
| λ = 395 | | | | | |
| Blue Light | 20874 | 0.3451, | 0.2062, | 568 | 572 |
| λ = 465 | | 0.3653 | 0.3275 | | |

In the technical characteristics of the present invention, the white light source adopts at least two semiconductor heterostructures (which are a first heterostructure 20 and a second heterostructure 30) instead of one heterostructure. The first heterostructure 20 and the second heterostructure 30 have radiations occurred at different short-wave radiating wave bands, wherein the first heterostructure 20 radiates at a near ultraviolet area and the second heterostructure 30 radiates at a blue light area. The first heterostructure 20 and second heterostructure 30 are produced by the same indium gallium nitride material and the same technique of producing the extension layer of the material. Therefore, they have the same electric properties and can be connected to the circuit in series or in parallel. The light emitting spectrum of the heterostructure varies with the InN content of the heterostructure.

The present invention adopts an overlapped portion of the radiation spectrum of the first heterostructure 20 and the radiation spectrum of the second heterostructure 30 that only occupies 10%˜30% of their maximum radiation. The maximum radiation of the first heterostructure 20 and the second heterostructure 30 is situated outside the overlapped spectrum area, wherein the peak of the first heterostructure 20 has a wavelength λ=390 nm˜395 nm, and the peak of the second heterostructure 30 has a wavelength λ=450 nm˜465 nm.

The white light LED light source of the invention has the following advantages: 1. The light color can vary in a large range of color temperature of 5000K˜12000K 2. The light emitting intensity is high which is over 2˜10 cd/m²; 3. The luminous flux is large, such that the luminous flux of the device can be up to 50 lumens. In addition to the foregoing advantages, the spectrum of the white light emitted varies if the electric parameters of the white light LED light source are changed. Such disclosure has never been disclosed in previously published journals or prior arts. If the second heterostructure 30 (blue light heterostructure) has a larger activation power, the light source will emit a cold color light. If the first heterostructure 20 (ultraviolet heterostructure) has a larger activation power, the light source emits a warm color light. These features of the white light LED light source are very significant, and also have never been disclosed in previously published journals or prior arts, and thus the white light LED light source of the present invention is novel and constitutes improvements.

The invention also provides a phosphor powder for a white light LED light source, and the phosphor powder is made of orthosilicate and has a chemical formula of Mg(Ca, Sr, Ba)₃Si₂O₈:(ΣMe^{2,3})(Hal)_{2,3}, and its activating light spectrum includes a first limit and a second limit, such that if the base of the phosphor powder is activated by ions and the ion concentration of the base satisfies a specific atomic fraction, said phosphor powder radiation spectrum is distributed in a green-yellow-orange visible spectrum area.

The first limit falls in a range of λ=360 nm˜400 nm, and the second limit falls in a range of λ=440 nm˜480 nm, and the specific atomic fraction is 0.005≦(ΣMe⁺^{2,3})≦0.1, and the maximum spectrum falls in a range of λ=560 nm˜590 nm.

The ion for activating the base of the phosphor powder 42 could be Ce⁺³+Mn⁺², Ce⁺³+Sn⁺², Eu⁺²+Dy⁺³, Eu⁺²+Pr⁺³, Eu⁺²+Y⁺³, Eu⁺²+Ce⁺³, Eu⁺²+Er⁺³, Eu⁺²+Gd⁺³ or Eu⁺²+La⁺³. The two-valent positive ions determine the light emitting spectrum of the phosphor powder 42 and the three-valent positive ions determine the light emitting spectrum of the phosphor powder 42, and the halogen ions determine the energy transfer of the activation core.

As described above, the brand new white light LED light source must produce high-quality light emissions by activating two different phosphor powders 42 with different wavelengths, which are the wave band of ultraviolet rays and the wave band of blue lights. These questions have not been disclosed in published journals or issued patents nor have any feasible solutions. As we know that standard phosphor powders using an aluminum yttrium garnet as their base can emit normal lights under normal activations, but cannot emit lights when activated by ultraviolet rays. In the Russian Pat. No. 2251761, the orthosilicate phosphor powder also has the same drawback. Therefore, the present invention solves another problem of emitting light by activating the phosphor powder 42 by two different lights of different wave bands.

In the present invention, the orthosilicate phosphor powder 42 used for the white light LED light source has the following features: the activated emitting light spectrum has two limits, one at an area with a wavelength λ=360 nm˜400 nm and another at an area with a wavelength λ=440 nm˜480 nm. If the base of the phosphor powder is activated by the ion activation (ΣMe^{+2,3}) in Ce⁺³+Mn⁺², Ce⁺³+Sn⁺², Eu⁺²+Dy⁺³, Eu⁺²+Pr⁺³, Eu⁺²+Y⁺³, Eu⁺²+Ce⁺³, Eu⁺²+Er⁺³, Eu⁺²+Gd⁺³ or Eu⁺²+La⁺³.If the ion concentration in the base can satisfy the atomic fraction 0.005≦(ΣMe^{+2,3})≦0.1, the radiation spectrum of the phosphor powder is distributed in a visible green-yellow-orange spectrum area, and the maximum spectrum has a wavelength λ=560 nm˜590 nm.

The foregoing problem can be solved by the light source built on the semiconductor device, wherein the phosphor powder is a two-element orthosilicate of the Group of Mg, Ca, Sr and Ba elements, and the two-valent and three-valent rare earth elements such as Ce⁺³+Mn⁺², Ce⁺³+Sn⁺², Eu⁺²+Dy⁺³, Eu⁺²+Pr⁺³, Eu⁺²+Y⁺³, Eu⁺²+Ce⁺³, Eu⁺²+Er⁺³, Eu⁺²+Gd⁺³ or Eu⁺²+La⁺³ are used as the activating elements, and the chemical formula for the phosphor powder is given by (Σ_{1,2,3,4}Me)₄₋ₓSi₂O₈:(TR⁺², TR⁺³)ₓHal_{2,3′}; where,

Me=Mg,Ca,Sr,Ba

TR⁺²=Eu⁺²

TR⁺³=Y, Gd, La, Lu, Pr, Tb, Ce, Dy, Er

Hal=F⁻¹ and/or Cl⁻¹ and/or Br⁻¹

And ΣMe₁⁺²+Me₂⁺²+Me₃⁺²+Me₄⁺²=4-x

X=0.001-0.1 is the atomic fraction.

The foregoing phosphor powder is overlapped by the spectrum of the activated emitting light and the short-wave radiation spectrum of the heterostructure, such that 10%˜30% of the maximum radiation spectrum of the heterostructure forms the spectrum converter 40. In addition, it is found in the development process of such item of the invention that the short-wave radiations of the blue light, violet light and ultraviolet heterostructure activate the phosphor powder to different extents. The phosphor powder with a chemical formula (Mg, Ca, Sr, Ba)₄₋ₓSi₂O₈.(Eu,Y)ₓ has a maximum activation spectrum occurred at the UVA wave band λ=395 nm˜405 nm, and the phosphor powder with a chemical formula (Ba,Sr,Mg,Ca)₄₋ₓSi₂O₈.(Eu,Er)ₓ has a maximum activation spectrum occurred at a wave band λ=395 nm˜445 nm, which is the blue light semiconductor heterostructure radiation area. Under this situation, the overall radiation of the diode comprised of the two heterostructures will have two maximum radiation spectra for the spectrum converter. One of the maximum radiations is related to the radiation of the oxidized two-valent positive activated ions and the other is formed by the same radiation of activated ions, but the radiation of this sort has higher energy than the former. The ultraviolet heterostructure 20 acutely activates the short-wave radiation of the spectrum converter 40, and the blue light heterostructure 30 induces a long-wave radiation. Further, the activating element pair in the base of the orthosilicate phosphor powder and the corresponding halide pair are selected for modulating the radiation spectrum, hue coordinates, and ratio color temperature of the spectrum converter 40.

The radiation of Eu⁺² ions has been discussed in many journals (such as the research result made by Poort), but the phosphor powder activated jointly by the ultraviolet heterostructure 20 (or violet light heterostructure) and the blue light heterostructure 30 has never been disclosed. In the foregoing situation, the spectrum converter 40 consisted of the (Ba, Sr, Mg, Ca) phosphor powder produces short-wave radiations at a bluish green light area or a green light area. In the meantime, the phosphor powder is activated by the blue light heterostructure to produce long-wave radiations at a yellow area, an orange area, or an orange red area. By then, the concentration of Sr⁺² and, Ca⁺² ions in the phosphor powder 42 is higher than the concentration of Ba⁺² and Mg⁺².

The color coefficient of the foregoing light source is Ra>90 which is a blue light radiation required by standard white light and comes from the blue light heterostructure.

Unlike existing light sources, the aforementioned white light source has a feature of changing its overall radiation by the electrical science. The electric power of the blue light heterostructure 30 is increased to achieve a high-temperature white light radiation, if needed. In this process, a large quantity of long-wave radiations is produced, and these long-wave radiations and the unabsorbed blue light provides light with a ratio color temperature T=2950˜5000K. Now, the electric power provided by the ultraviolet heterostructure 20 is lower, so as to assure a small quantity of short-wave radiations produced by the blue, bluish green and green areas in the overall radiation.

If a low-temperature white light radiation is needed, then it is necessary to supply a large quantity of power to the ultraviolet heterostructure 20. Now, the radiations of the spectrum converter 40 occur at the blue, bluish green and green areas. In the meantime, the unabsorbed violet light radiation of the heterostructure will produce a white light with a ratio color temperature T>8000K.

In the description above, the light source of the white light semiconductor not only has the advantage of providing a special architecture by introducing two heterostructures 20, 30 to produce radiations of different wavelengths, but also provides a spectrum converter 40 made of an orthosilicate phosphor powder 42.

Compared with the Russian Pat. No. 2251761, the phosphor powder 42 of the invention includes four types of alkaline earth metal elements (Mg, Ca, Sr and Ba) instead of two or three types. The ratio of these four elements falls in the range from 1:0.01:0.69:0.30 to 1:0.1:0.2:0.7. The data obtained from the development of the present invention shows that the effect on different combinations of these four elements varies. The Ba⁺² is combined with the active Eu⁺². Since a f˜d leap occurs in the ions, a green light emitting core is produced, and the small Sr⁺² replaces the large Ba⁺² to form yellow light and orange light emitting cores. The Eu⁺² forms a red emitting light core under the action of Ca orthosilicate. The smallest Mg⁺² forms a stable ionic bond, such that the crystal lattice of the orthosilicate phosphor powder is more stable. The addition of Mg⁺² can improve the melting point of the base of the phosphor powder to 100° C., and also can modulate the particle size of the phosphor powder.

Further, addicting ions of the halogen group into the base of the orthosilicate phosphor powder is a complicated experimental process for composing the phosphor powder 42, and such process can be achieved by a high-pressure evaporation of halogen compounds.

If the concentration of the filled phosphor powder 42 is a minimum, then the original radiation will penetrate through the spectrum converter 40. If the concentration of the filled phosphor powder 42 is a maximum, then the spectrum converter 40 cannot mix its original radiation with the activated radiation, and thus cannot obtain the final white light. Firstly, the compound is dissolved in the corresponding solvent, and the solution is a suspension containing the phosphor powder 42, and the suspension is dropped onto the light emitting surface 23, 33 of the heterostructure 20, 30 by a micro measurer to form a thin film of 80 microns to 200 microns thick, and the original radiation of the heterostructure 20, 30 is changed drastically during the process of activating the spectrum converter 40 to emit lights, so as to mix the original radiation with the activated radiation to form the final white light.

The white light LED light source of the invention includes at least two InGaN short-wave heterostructures with different radiation wavelengths, and the phosphor powder 42 in this light source has the effect of a spectrum converter 40. The following solutions are available for producing this kind of phosphor powder 42. The first one of the methods belongs to the category of solid phase synthesis that employs a powder material, and the second one belongs to the category of colloid chemistry, and is called the sol-gel process.

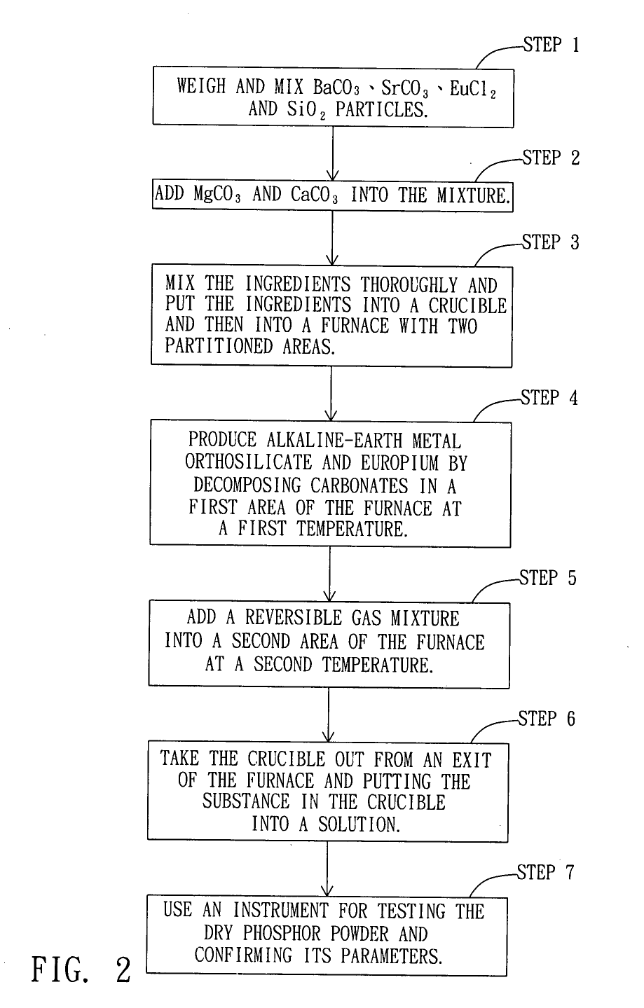

Referring to FIG. 2 for a method for producing a phosphor powder according to a preferred embodiment of the present invention, the method is a solid phase synthesis method that comprises the steps of: weighing and mixing BaCO₃, SrCO₃, EuCl₂ and SiO₂ particles (Step 1); adding MgCO₃ and CaCO₃ into the mixture (Step 2); mixing the ingredients thoroughly and putting the ingredients into a crucible and then into a furnace with two partitioned areas (Step 3); producing alkaline-earth metal orthosilicate and europium by decomposing carbonates in a first area of the furnace at a first temperature (Step 4); adding a reversible gas mixture into a second area of the furnace at a second temperature (Step 5); taking the crucible out from an exit of the furnace and putting the substance in the crucible into a solution (Step 6); and using an instrument for testing the dry phosphor powder and confirming its parameters (Step 7).

In Step 1, the BaCO₃ weighs 30 g, the SrCO₃ weighs 100 g, the EuCl₂ weighs 0.9 g and the SiO₂ weighs 30 g, and the BaCO₃, SrCO₃, EuCl₂ and SiO2 particles are supper dispersing particles with a particle diameter of 10 nm˜50 nm.

In Step 2, the MgCO₃ weighs 10 g and the CaCO₃ weighs 5 g.

In Step 3, the crucible is an alundum crucible.

In Step 4, the carbonates are decomposed into alkaline-earth metal orthosilicate and europium in a first area of the furnace when the temperature rises to the first temperature, wherein the first temperature is 1300° C.

In Step 5, a reversible gas mixture is added into a second area of the furnace when the temperature rises to the second temperature, wherein the second temperature is 1260° C., and the reversible gas mixture contains H₂:N₂=5:95.

In Step 6, the crucible is taken out from an exit of the furnace and the substance in the crucible is put into a solution, wherein the solution is a CH₃COOH solution, and its ratio is 1:10.

In Step 7, an instrument is used for testing the dry phosphor powder and confirming its parameters, wherein the instrument is a CS-2102 instrument for testing the parameters such as brightness, radiation brightness, chromaticity coordinates, peak wavelength of the phosphor powder 42.

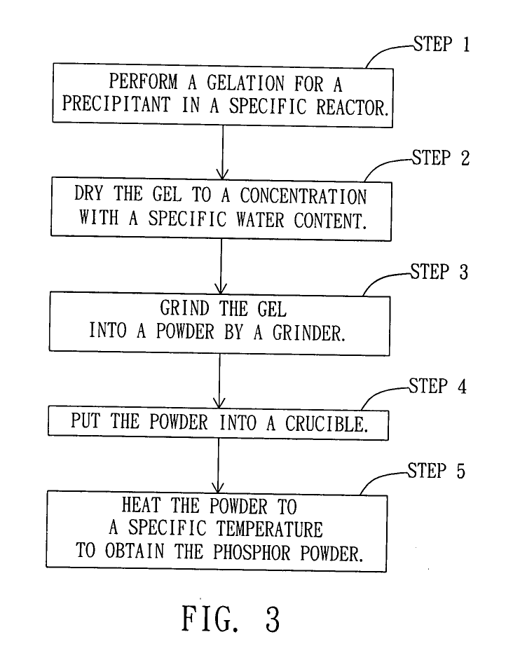

Referring to FIG. 3 for a flow chart of a method for producing a phosphor powder according to another preferred embodiment of the present invention, the method for producing a phosphor powder is a sol-gel process and comprises the steps of: performing a gelation for a precipitant in a specific reactor (Step 1); drying the gel to a concentration with a specific water content (Step 2); grinding the gel into a powder by a grinder (Step 3); putting the powder into a crucible (Step 4); and heating the powder to a specific temperature to obtain the phosphor powder (Step 5).

In Step 1, a gelation is performed for a precipitant in a specific reactor, and the precipitant is H₄Si_{3.5}F_{0.5}.

In Step 2, the gel is dried to a concentration with a specific water content, wherein the concentration of specific water content is water content of 5%˜10%.

In Step 3, a grinder is used for grinding the gel into powder, wherein the grinder is a planetary mill.

In Step 4, the powder is put into a crucible, wherein the crucible is an alundum crucible.

In Step 5, the powder is heated to a specific temperature to obtain the phosphor powder, wherein the specific temperature does not exceed 1150° C.

Table 2 shows the chemical formula of the phosphor powder produced according to the method of a preferred embodiment of the present invention, and Table 2 lists a main spectrum and a light emitting index of a phosphor powder.

Table 2 lists the main parameters and corresponding chemical
composition of the phosphor powder of the invention.

| | | Brightness (%) of | | |
|---|---|---|---|---|
| | | corresponding | | |
| | | activated | | |
| | | emitting light | Chromaticity | Radiation |
| | | with a | coordinates | wavelength |
| | Chemical Composition | wavelength λ = 460 nm | (x, y) | (nm) |
| 1. | Mg(Ca, Sr, Ba)₃Si₂O₈, Eu⁺², Y, Cl (0.005) | 60 | 0.46, 0.52 | 569 |
| 2. | Mg(Ca, Sr, Ba)₃Si₂O₈, Eu⁺², Cl (0.01) | 100 | 0.42, 0.54 | 555 |
| 3. | Mg(Ca, Sr, Ba)₃Si₂O₈, Eu⁺², Mn, Cl (0.01) | 75 | 0.44, 0.50 | 550, 630 |
| 4. | Mg(Ca, Sr, Ba)₃Si₂O₈, Eu⁺², Sn⁺², F (0.01) | 82 | 0.45, 0.51 | 555, 670 |
| 5. | Mg(Ca, Sr, Ba)₃Si₂O₈, Eu⁺², Pr⁺³, Cl (0.02) | 105 | 0.40, 0.54 | 555, 615 |
| 6. | Mg(Ca, Sr, Ba)₃Si₂O₈, Eu⁺², Gd, F (0.01) | 79 | 0.45, 0.52 | 559 |
| 7. | Mg(Ca, Sr, Ba)₃Si₂O₈, Eu⁺², Ce⁺³, F (0.01) | 80 | 0.40, 0.51 | 549 |
| 8. | Mg(Ca, Sr, Ba)₃Si₂O₈, Eu⁺², Sm⁺², F (0.01) | 65 | 0.46, 0.52 | 572 |
| 9. | Mg(Ca, Sr, Ba)3Si₂O₈, Eu⁺², Yb⁺², Cl (0.01) | 112 | 0.46, 0.52 | 558 |
| 10. | Mg(Ca, Sr, Ba)₃Si₂O₈, Eu⁺², Y, Cl (0.01) | 150 | 0.26, 0.62 | 522 |
| 11. | (Ba_{0.3}Sr_{0.7})₂SiO₄, Eu⁺², F(0.04) Standard | 100 | 0.42, 0.52 | 560 |
| | Sample | | | |

From the data in Table 2, the chromaticity coordinates of the light emitted by the phosphor powder completely shade the green, yellow and orange wave bands of the spectrum and its peak wavelength falls within the range from 522 nm to 670 nm. This type of phosphor powder is not only used as the main material for the spectrum converter, but also serves as a resupply for the yellowish green phosphor powder.

All of the aforementioned phosphor powders have a very high brightness when activated by a light with a wavelength λ=460 nm, and the brightness of the emitted light is much greater than the brightness of the emitted light of a standard sample produced by a major U.S. manufacturers when activated by ultraviolet rays with a wavelength λ=395 nm.

As mentioned previously, the heterostructures are combined integrally, and they can be connected in parallel or in series. If the heterostructures having different resistivity are used, the serial connection is usually employed. The light emitting surface of the spectrum converter 40 coated with a phosphor powder 42 is connected with the blue light and ultraviolet heterostructures 20, 30 in parallel to constitute a white light source. In this parallel circuit, optical resistors are connected in series for modulating the current intensity of the heterostructures 20, 30, and these resistors are provided by the resistors in the heterostructures. If the current intensity of the blue light heterostructure 30 falls within 20 mA˜40 mA, the blue light portion in the overall luminous flux will be increased. In the meantime, the radiation spectrum of the spectrum converter 40 shifts to the long-wave wave band. The luminous flux of the long-wave radiation exceeds the luminous flux of the light emitted by the ultraviolet heterostructure 20 and the light emitted by activating the spectrum converter 40. The overall emitted light is warm hue, and the color temperature is at 3100K˜5800K. If the current intensity of the ultraviolet heterostructure is increased, then the situation will be opposite. In other words, the luminous flux of the short-wave radiation will be increased and the color temperature T>7000 K.

It is noteworthy to point out that the semiconductor light source has a very large luminous flux. If a pair of heterostructures 20, 30 are connected in parallel and situated at an electric power W=0.20 w, then the luminous flux F≧6 lm, and the light emitting efficiency η≧30 lm/w. If a high-quality nitride heterostructure with a surface area S>1=2 is adopted and its electric power W=0.6 w, then the luminous flux F≧30 lm, and the light emitting efficiency η≧50 lm/w.

The white light LED light source in accordance with the present invention is novel in both electricity and material fields, and its optical structure is improved. To avoid the output of white light from dual frequency band semiconductor light sources, a cylindrical lens is used as an emitter, and the geometric axis of the lens passes through the geometric center of the light emitting heterostructure. This type of cylindrical lens emitter can eliminate the chromatic aberration of the light emission.

In summation of the description above, the white light diode of the present invention is comprised of at least two different heterostructures that radiate blue and ultraviolet lights of different wavelengths, and also includes a spectrum converter activated for producing a radiation to be mixed with the radiation of a nitride heterostructure to produce a white light and modulating the hue of the white light by changing the electric power of the heterostructure. Therefore, the invention definitely can overcome the shortcomings of the prior art white light diode and its method of producing phosphor powder.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A white light LED light source, made of indium gallium nitride, and comprising:
an insulating crystal frame, for carrying a first heterostructure and a second heterostructure,
and said first heterostructure having an anode, a cathode and a light emitting surface, and said anode and cathode of said first heterostructure being exposed from said insulating crystal frame,
and said second heterostructure disposed on a side of said first heterostructure and having an anode, a cathode and a light emitting surface, and said anode and cathode of said second heterostructure being exposed from said insulating crystal frame;
a spectrum converter, covered onto a light emitting surface above said first heterostructure and said second heterostructure; and
an optical casing, being disposed above said spectrum converter and coupled to said insulating crystal frame to define an airtight status.

2. The white light LED light source of claim 1, wherein said first heterostructure is an ultraviolet heterostructure with a maximum radiation of 360 nm˜400 nm.

3. The white light LED light source of claim 2, wherein said second heterostructure is a blue light heterostructure with a maximum radiation of 440 nm˜480 nm.

4. The white light LED light source of claim 1, wherein said first heterostructure and said second heterostructure have an overlapped portion of radiation spectrum equal to 10%˜30% of their maximum radiation, and identical electric properties, and said first and second heterostructures can be connected in a circuit in series or in parallel, and their light emitting spectra varies with their InN content.

5. The white light LED light source of claim 1, wherein said spectrum converter is formed by mixing a transparent organic resin and a phosphor powder.

6. The white light LED light source of claim 5, wherein said organic resin is a high-temperature curing epoxy resin, polycarbonate or organosilicon compound, and said phosphor powder is made of orthosilicate.

7. The white light LED light source of claim 6, wherein said phosphor powder has a chemical formula of Mg(Ca, Sr, Ba)₃Si₂O₈:(ΣMe^{2,3})(Hal)_{2,3}.

8. The white light LED light source of claim 1, further comprising a reflector for adjusting the direction of radiating light of said first heterostructure, said second heterostructure and said spectrum converter, and said reflector can be electrically coupled with a power supply of said white light LED light source.

9. A phosphor powder of a white light LED light source, made of orthosilicate, and having a chemical formula of Mg(Ca, Sr, Ba)₃Si₂O₈:(ΣMe^{2,3})(Hal)_{2,3}, and its activated light emitting spectrum includes a first limit and a second limit, such that if the base of said phosphor powder is activated by ions and the ion concentration of said base satisfies a specific atomic fraction, said phosphor powder radiation spectrum is distributed in a green-yellow-orange visible spectrum area.

10. The phosphor powder of claim 9, wherein said first limit falls in a range of λ=360 nm˜400 nm, and said second limit falls in a range of λ=440 nm˜480 nm, and the maximum spectrum falls in a range of λ=560 nm˜590 nm.

11. The phosphor powder of claim 9, wherein said ion is Ce⁺³+Mn⁺², Ce⁺³+Sn⁺², Eu⁺²+Dy⁺³, Eu⁺²+Pr⁺³, Eu⁺²+Y⁺³, Eu⁺²+Ce⁺³, Eu⁺²+Er⁺³, Eu⁺²+Gd⁺³ or Eu⁺²+La⁺³.

12. The phosphor powder of claim 11, wherein said two-valent positive ions determine the light emitting spectrum of said phosphor powder and said three-valent positive ions determine the activated light emitting spectrum of said phosphor powder and said halogen ions determine the energy transfer of said activation core.

13. The phosphor powder of claim 11, wherein said specific atomic fraction is 0.005≦(ΣMe^{+2,3})≦0.1.

14. The phosphor powder of claim 9, wherein said phosphor powder has an average diameter of 10 nm≦d≦14 nm and a median of 4 nm≦d₅₀≦10 nm.
